(19) United States
(12) Patent Application Publication
(10) Pub. No.: US 2016/0371699 A1
(43) Pub. Date: Dec. 22, 2016

(54) Method for Financial Fraud Prevention Through User-Determined Regulations

(71) Applicant: Reginal Robert Proctor, Henderson, NV (US)

(72) Inventor: Reginal Robert Proctor, Henderson, NV (US)

(21) Appl. No.: 15/187,628

(22) Filed: Jun. 20, 2016

Related U.S. Application Data
(60) Provisional application No. 62/182,297, filed on Jun. 19, 2015.

(51) Int. Cl. G06Q 20/40; G06Q 20/24

(52) U.S. Cl. CPC G06Q 20/4016; G06Q 20/409; G06Q 20/24

(57) ABSTRACT

A credit card fraud-prevention system which allows user accounts to customize a personal portfolio to monitor their individual transactions. The system allows each user account to pick a plurality of fraud-prevention criteria to monitor a payment card(s). The overall process begins with receiving payment transaction data with a remote server. A matching account is then identified for the payment transaction data by searching through a card identification information of each user account. Once the matching account is identified, the remote server then compares the payment transaction data to each fraud-prevention criteria in order to identify a met criterion. If the met criterion is not identified, then the payment transaction data is verified and sent to financial entities. If the met criterion is identified, then a predefined response of the met criterion is executed. This includes notifying the matching account about the possible fraudulent activity and requesting verification for the transaction.

The current application claims a priority to the U.S. Provisional Patent application Ser. No. 62/182,297 filed on Jun. 19, 2015. The current application is filed on Jun. 20, 2016 while Jun. 19, 2016 was on a weekend.

### FIELD OF THE INVENTION

The present invention relates generally to credit card fraud detection and prevention system and methodologies. More specifically, the present invention is a fraud detection method which utilizes user-defined rules/regulations in order to authorize and validate transactions. The objective of the present invention is to allow the user to customize the conditions under which fraud alerts are triggered, therefore minimizing chances of false positives.

### BACKGROUND OF THE INVENTION

Present day, credit card fraud detection systems may be unreliable, inconsistent and are reactive to events/transactions that have already occurred. Additionally, there are oftentimes false positives as well as false negatives. In the past, there have been situations where a user has had a payment card defrauded within a short time period of just a month. For example, there was once a user in the United States whose card was not flagged when two thousand dollars' worth of lumber was purchased in England. Soon afterwards, a local gas station in the United States near the user flagged down a legitimate, miniscule purchase at a gas station as potentially fraudulent. The reasons for such occurrences are due to the flaws inherent in conventional credit card fraud detection systems.

Current credit card transaction methodologies employ an authorization, batching, clearance and settlement process that provides only a modicum of fraud detection and prevention before completing each transaction. Credit card transaction authorizations are typically requested using a transaction acquiring device, such as a point-of-sale (POS) terminal or an automated teller machine (ATM). The transaction acquiring device then transmits transaction data derived from the card, e.g. account number, the terminal, e.g. merchant number, the transaction, e.g. the amount, together with other data which may be generated dynamically or added by intervening systems to the card issuer. The card issuer can be a banking entity or authorized clearing house. Upon receipt, the card issuer or authorized clearing house either authorizes or declines the transaction, and generates a response message which must be delivered back to the transaction acquiring device within a predefined time period.

Each credit card transaction authorization is based, almost exclusively, upon five factors: whether the cardholder's account is in good standing, the card is a valid card meaning it is not yet expired or reported lost or stolen, there is a valid verification/security code, there is credit availability or sufficient funds in the case of a debit card, and whether the merchant/seller account is in good standing.

Curiously, most cardholders are in “good standing” with available credit or funds, and there are very few circumstances when a merchant number trips any kind of security protocol. This means that virtually any transaction that occurs with a stolen card or stolen card number, especially if the thief possesses the card verification/security code. In such situations, the card will be honored almost without question until a lost or stolen alert is manually placed on the account by the user.

Although card associations, card issuers and authorized clearing house organizations employ, with increasing success, a wide variety of proprietary algorithms and monitoring techniques to detect unusual card usage, monitoring criteria such as transaction size, location, type of purchase, and number of transactions in a short period of time, etc., these precautions are designed to limit losses, not prevent them. By the time a stolen card is “flagged”, a loss has already occurred and the perpetrator is unlikely to be caught. An objective of the present invention is to overcome such problems.

Since current credit card transaction procedures preclude the consumer from verifying or authenticating individual transactions, current methods expose both the consumer and the card-issuing bank to unnecessary and potentially significant financial risk. The present invention enables the user to play a role in fraud detection and prevention before transactions are submitted to the card association, card-issuing bank, or authorized clearing house for approval.

The present invention significantly improves authentication and verification of individual financial transactions and prevent most forms of credit card fraud and credit card data theft, and be applied to bank wire transfers and other high value or fraud-prone financial transactions. The key aspect of the present invention is that it allows the user to create a set of rules for defining what passes authentication. It is notable because the set of rules is user-defined instead of card issuer-defined, and allows the user to stipulate what transactions pass and what do not. The set of rules is more numerous and comprehensive than conventional card-issuer based processes, which attempt to perform a similar function, and utilizes different processes.

In the most general sense, the present invention is a system by which a user can very accurately and narrowly define a customized portfolio which governs the authorization and rejection of the transaction for the associated payment card based on a variety of conditions. The present invention is most notably used for preventing credit card fraud but may also be utilized to control the spending of others. For example, controlling the spending ability of a payment card when it is handed over to a secondary party, a spouse or child.

The set of rules comprises specific criteria for validation and authentication, including but not limited to: location, type of merchant, type of transactions, past usage history, etc. For example, if so configured, if the transaction takes place more than 50 feet from the user's smartphone, the transaction can be flagged as potentially fraudulent since the user is assumed to always be in proximity of his smartphone. If the user commonly travels between cities such as New York City and Los Angeles, the user can flag instances of credit card use outside of a certain radius of those locations. This way, the distance between the transactions is not an issue, but the geographic location. To reiterate, the purpose of the present invention is to provide a greater sense of continuity in terms of authentication checking and alerts, thus striking an optimum balance between convenience and security, without the blanket policies which often lead to false positives or false negatives.

### BRIEF DESCRIPTION OF THE DRAWINGS

FIG. 1 is a system diagram of the present invention.

FIG. 2 is a flowchart depicting the overall process of the present invention.

FIG. 3 is a flowchart depicting the steps necessary to configure a plurality of fraud-prevention criteria for each of a plurality of user accounts.

FIG. 4 is a flowchart depicting the steps necessary to receive else-defined settings for the fraud-prevention criteria of a secondary account, wherein the else-defined settings are entered by the primary account.

FIG. 5 is a flowchart depicting the steps necessary to receive a selected plurality of fraud-prevention criteria for each of the user accounts.

FIG. 6 is a flowchart depicting the steps necessary to check a value-limit criterion from the plurality of fraud-prevention criteria.

FIG. 7 is a flowchart depicting the steps necessary to check a restricted location criterion from the plurality of fraud-prevention criteria.

FIG. 8 is a flowchart depicting the steps necessary to check a restricted merchant criterion from the plurality of fraud-prevention criteria.

FIG. 9 is a flowchart depicting the steps necessary to check a restricted transaction-type criterion from the plurality of fraud-prevention criteria.

FIG. 10 is a flowchart depicting the steps necessary to check a user-proximity criterion from the plurality of fraud-prevention criteria.

FIG. 11 is a flowchart depicting the steps necessary to check a secondary user-proximity criterion from the plurality of fraud-prevention criteria.

FIG. 12 is a flowchart depicting the steps necessary to check a spacetime possibility criterion from the plurality of fraud-prevention criteria.

FIG. 13 is a flowchart depicting the steps necessary to implement the present invention prior to authorization by an authorized financial entity.

FIG. 14 is a flowchart depicting the steps necessary to implement the present invention after the payment transaction data is authorized by the authorized financial entity.

FIG. 15 is a flowchart depicting the steps necessary to execute one type of predefined action for a met criterion.

### DETAIL DESCRIPTIONS OF THE INVENTION

All illustrations of the drawings are for the purpose of describing selected versions of the present invention and are not intended to limit the scope of the present invention.

The present invention generally relates to credit card fraud prevention system. More specifically, the present invention is a credit card fraud prevention system which allows users to define and customize a set of user-defined criteria for verifying each transaction request issued for his or her financial account. The key aspect of the present invention is that each transaction is verified by the set of user-defined criteria prior to being submitted to a financial entity for processing and execution. This prevents unnecessary and potentially significant financial loss to the user and the financial entity as potential fraud requests are caught prior to execution. The present invention continuously monitors and analyzes the transactions for the financial account of the user without requiring continuous input from the user. The present invention may be implemented as a stand-alone service for individuals and financial entities. Alternatively, the present invention may be integrated into the protocols and processes of the financial entities.

The present invention comprises a system and a method that provide a novel credit card fraud prevention system. The method is a software application executed by the system of the present invention for a plurality of user accounts. Each of the user accounts allows a different individual to interact with the present invention. The plurality of user accounts is managed by at least one remote server and is associated with at least one card identification (ID) information (Step A). The card ID information is used to identify one payment card from another payment card. The card ID information includes, but is not limited to, a card number, a first name, a last name, a card type, and a card verification/security code. A variety of payments cards may be used with the present invention including, but not limited to, credit cards, debit cards, and gift cards.

Each of the user accounts is further associated with a plurality of fraud-prevention criteria, wherein each of the fraud-prevention criteria is associated to a predefined response (Step B). The plurality of fraud-prevention criteria is a set of rules designed to analyze and monitor a transaction in order to identify irregular and suspicious card activity. Types of information that may evaluated/included in the plurality of fraud-prevention criteria include transaction size, location of transaction, transaction type, and merchant type for the transaction to name a few non-limiting examples. The plurality of fraud-detection criteria is selected by and customized for each of the user accounts to meet his or her personal preference and financial standing. In the case that one of plurality of fraud-detection criteria is met, the present invention executes the predefined response that is associated with the met criterion. One of the main action responses is sending the transaction information to the associated user account and requesting verification, thus including the individual in the fraud-prevention processes.

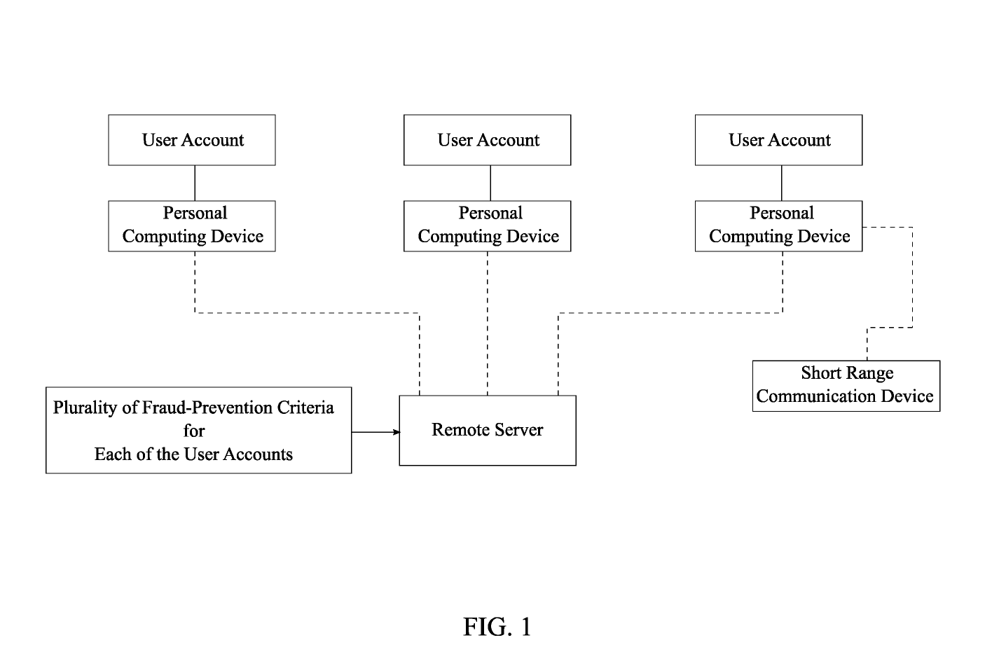

Referring to FIG. 1, from the system perspective of the present invention, each of the user accounts is associated to a corresponding personal computing (PC) device. Each of the user accounts is enabled to interact with the present invention through the corresponding PC device. Type of devices that may be used as the PC device include, but are not limited to, a smartphone, a desktop computer, a laptop, a tablet, and any other device with Internet capabilities. Additional constituents of the system include a transaction-acquiring device and an authorized financial computing device. The transaction-acquiring device is associated with a merchant and is the component which submits transaction requests for authorization and execution. Two of the most common transaction-acquiring devices are a point-of-sale (POS) terminal and an automated teller machine (ATM). The authorized financial computing device is associated with a financial entity. The financial entity is a financial establishment which authorizes, manages, and executes transactions. Two of the main financial entities are a bank and an authorized clearing house.

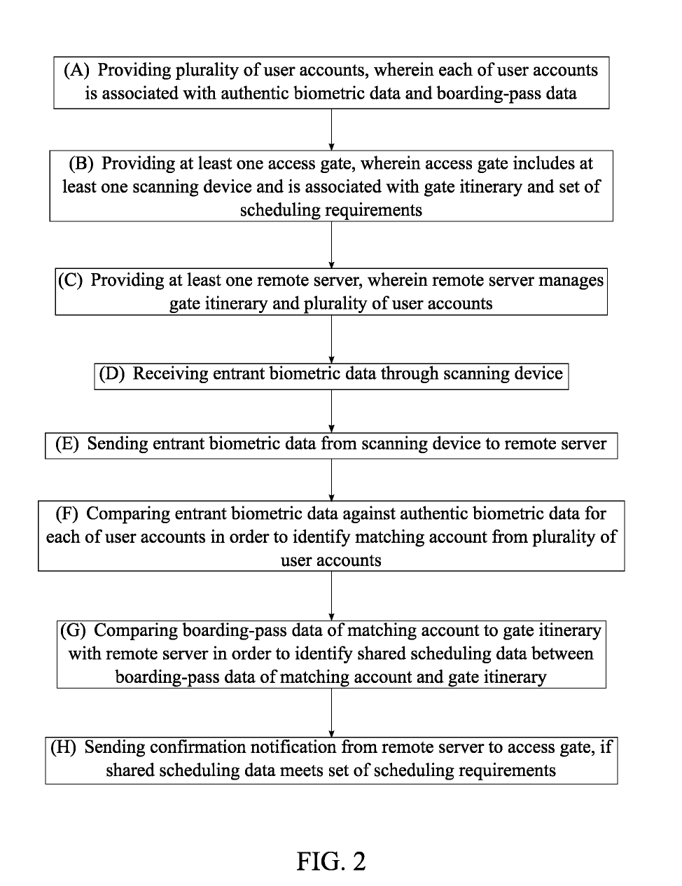

Referring to FIG. 2, the overall process of the present invention delineates steps necessary to prevent credit card fraud from occurring. The overall process begins with payment transaction data being received with remote server (Step C). The payment transaction data includes, but is not limited to, a card number, a cardholder's name, a merchant identification (ID), a merchant location, a card verification value, and any other information required for the transaction authorization. First, the present invention identifies which user account the transaction data is associated with. More specifically, the payment transaction data is compared to the card ID information for each of the user accounts with the remote server in order to identify a matching account from the plurality of user accounts (Step D). The two important pieces of information compared during this step are the card number and the user name, alternative information may also be utilized. Next, the remote server compares the payment transaction data against each of the fraud-prevention criteria of the matching account in order to identify at least one met criterion from the plurality of fraud-prevention criteria of the matching account (Step E). One of the main aspects of the present invention is implementing this check before the transaction data is executed and as a result preventing fraud from occurring without any financial loss, a common occurrence in current credit card fraud methodologies. If the met criterion is not identified during Step E, then the remote server verifies the payment transaction data (Step F). The verified payment transaction data is then sent to the appropriate financial entity for execution. Alternatively, if the met criterion is identified during Step E, then the predefined response associated to the met criterion is executed with the remote server (Step G). In other words, this triggers an alarm for the matching account and/or the financial entity. One type of predefined response includes the system requesting the matching account to verify the transaction data. Another type of predefined response includes a simple notification being sent to the matching account.

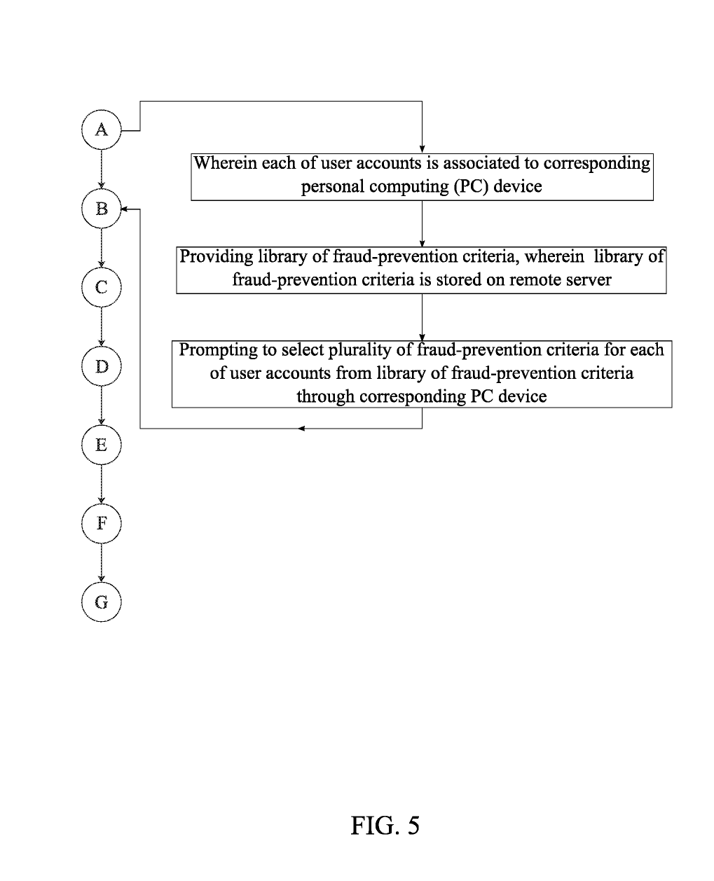

Referring to FIG. 5, the present invention allows each of the user accounts to pick and choose the type of criteria used to monitor his or her financial account/payment card. More specifically, the present invention includes a library of fraud-prevention criteria, wherein the library of fraud-prevention criteria is managed and stored on the remote server. Type of fraud-prevention criteria includes, but is not limited to, a value-limit criterion, a restricted location criterion, a user-proximity criterion, a spacetime possibility criterion, a secondary user-proximity criterion, a restricted merchant criterion, and a restricted transaction-type criterion. Each of the fraud-prevention criteria is discussed in further detail below.

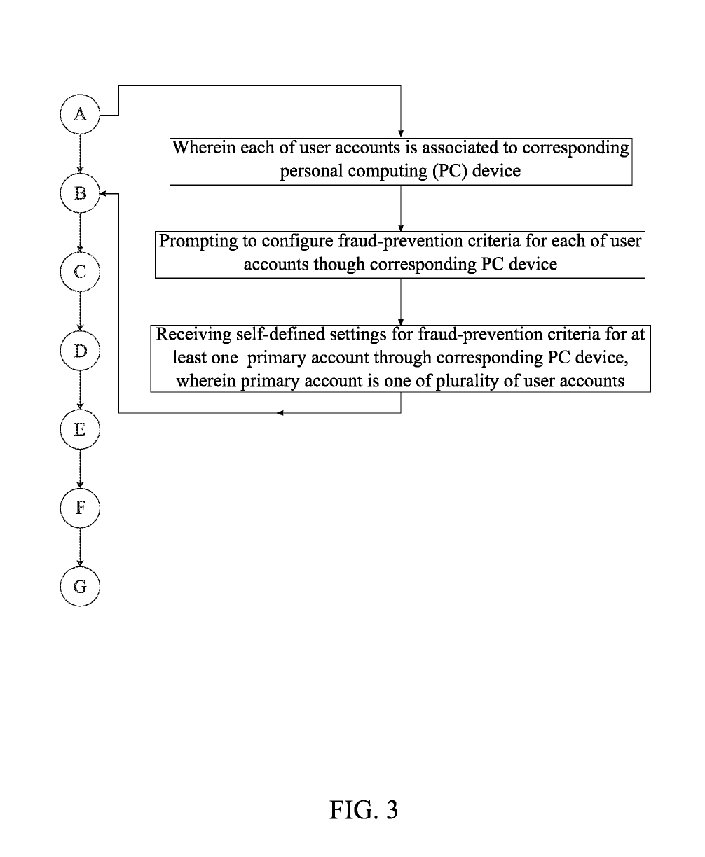

During the registration process for the present invention, each of the user accounts is first prompted to select the plurality of fraud-prevention criteria for his or her financial account/payment card from the library of fraud-prevention criteria through the corresponding PC device. The constituents of the plurality of fraud-prevention criteria can be changed at any time throughout the overall process of the present invention by each of the user accounts. Next, each of the user accounts is further prompted to configure the fraud-prevention criteria through the corresponding PC device, seen in FIG. 3. This includes configuring each of the fraud-prevention criteria to suit the needs, financial status, and personal preference of each individual. For example, for the value-limit criterion, this includes setting a maximum value threshold for each of the transactions, which when broken will trigger the predefined response associated with the value-limit criterion; e.g. a request for verification from the user account. It is not necessary for each of the user accounts to configure the fraud-prevention criteria as each of the fraud-prevention criteria is initially set to a default configuration. If an arbitrary account chooses to configure the fraud-prevention criteria, the present invention receives the configuration in the form of self-defined settings for the fraud-prevention criteria. The self-defined settings are user inputs for the limits and variables of the fraud-prevention criteria. The arbitrary account represents any one of the plurality of user accounts. The configured fraud-prevention criteria are then stored and associated with the arbitrary account by the remote server.

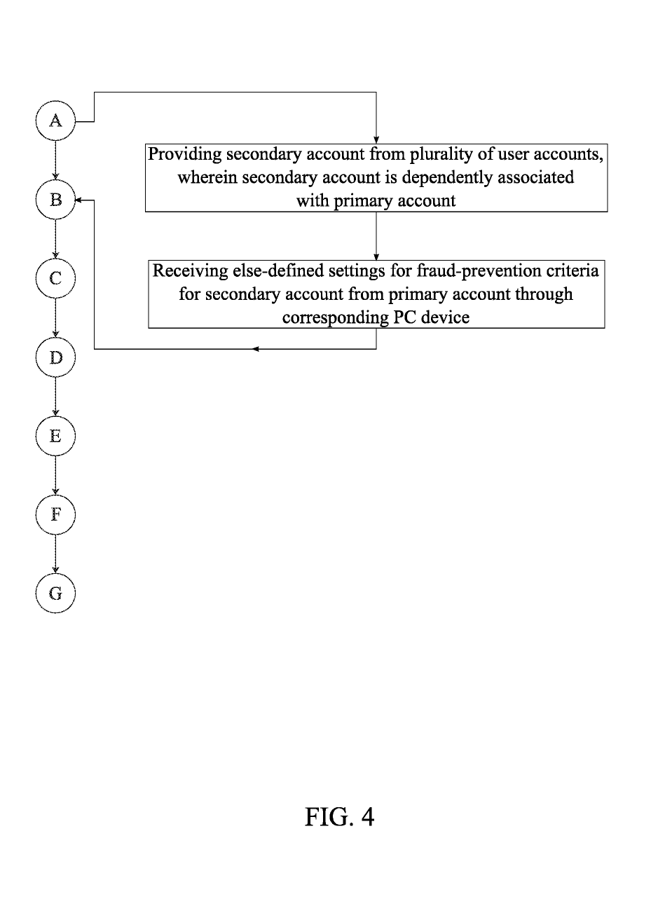

Referring to FIG. 4, in one embodiment, the present invention allows one of the user accounts to manage/control the fraud-prevention criteria of another account. More specifically, a primary account from the plurality of user accounts possesses administrative capabilities for the corresponding fraud-prevention criteria and for the fraud-prevention criteria of a secondary account. The secondary account is one of the plurality of user accounts and is also dependently associated with the primary account. During the registration process, the present invention receives else-defined settings for the fraud-prevention criteria for the secondary account from the primary account through the corresponding PC device. In other words, the primary account configures and enters the else-defined settings, or variables for limits, for the fraud-prevention criteria of the secondary account. This feature allows a parent to control the spending of his or her child, especially useful when the child is using the parent's credit card account.

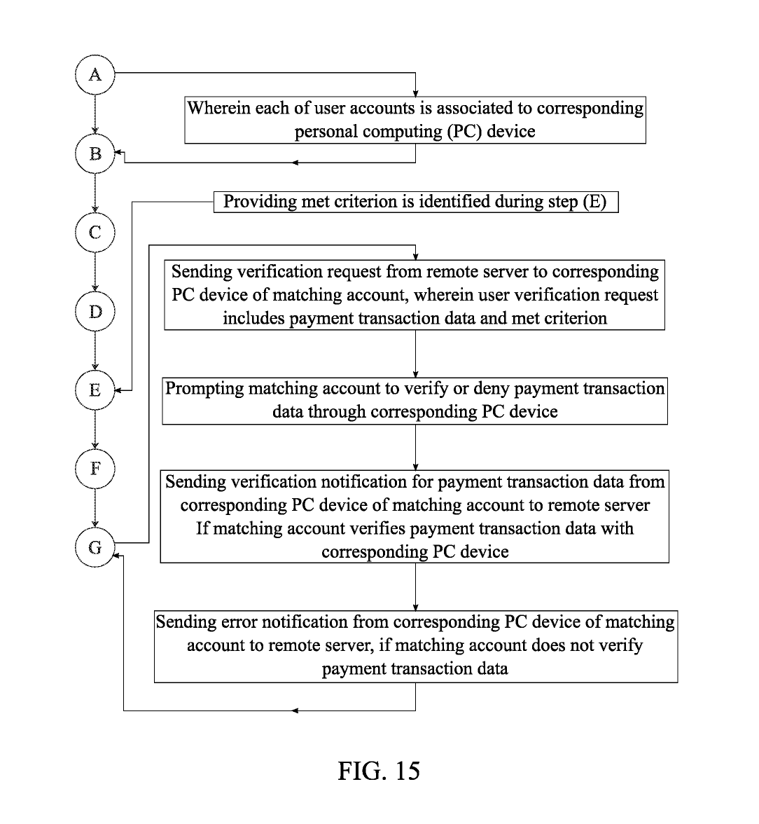

Referring to FIG. 15, one of the main predefined responses that may be used during Step G is a user verification request, wherein the present invention includes requesting the matching account to verify the payment transaction data. Provided that the met criterion is identified during Step E and the predefined response for the met criterion is the user verification request, the present invention first sends a verification request from the remote server to the corresponding PC device of the matching account, wherein the verification request includes the payment transaction data and the met criterion. The verification request may be sent in the form of an email, text message, or other similar medium of communication. This allow the matching account to view the payment transaction data and the met criterion in order to decide whether or not to allow the payment transaction to go through. For example, the verification request may include a statement reading “You are being notified because an attempted transaction occurred too far from your location, your limit is 50 feet”; wherein the user-proximity criterion is met for this example. More specifically, the matching account is prompted to verify or deny the payment transaction data through the corresponding PC device. If the matching account verifies the payment transaction data, then a verification notification for the payment transaction data is sent from the corresponding PC device of the matching account to the remote server. The user account may verify the payment transaction data through a variety of means including, but not limited to, entering a preset confirmation password, entering the four-digit verification/security code of the payment card, responding with a “yes” text message, and entering the PIN number of the payment card. A variety of means may be used to receive a verification from the matching account. Alternatively, if the matching account does not verify the payment transaction data, then an error notification is sent from the corresponding PC device to the remote server. The user verification request provides the individual with a direct feedback link to the present invention.

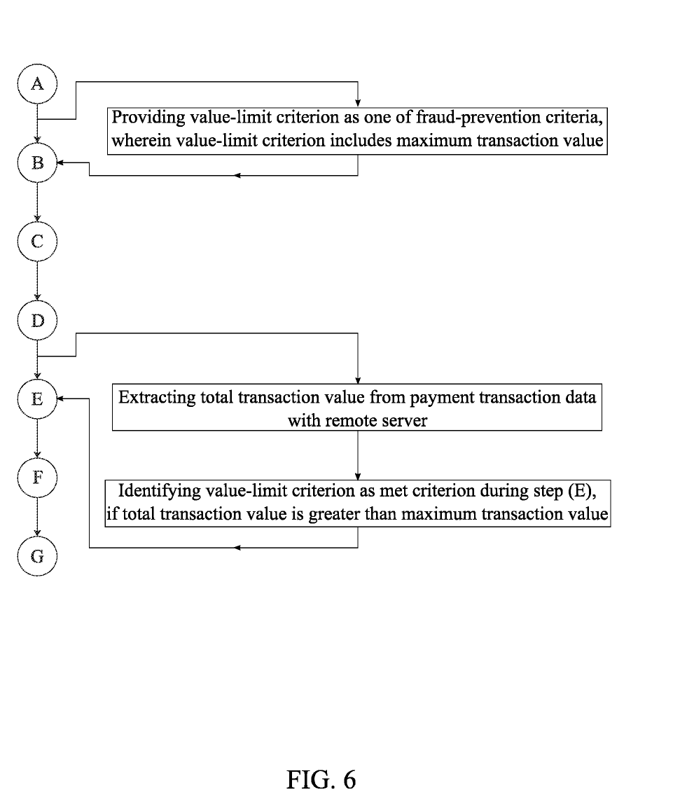

Referring to FIG. 6, the value-limit criterion sets a maximum value for each of the transactions. The value-limit criterion is designed to identify any transaction requests over a certain spending limit, a maximum transaction value. High value transaction is most often times a good indicator of potential fraud. In order to check the value-limit criterion, the remote server first extracts a total transaction value from the payment transaction data. Next, the total transaction value is compared against the maximum transaction value. If the total transaction value is greater than the maximum transaction value, then the value-limit criterion is met and identified as the met criterion during Step E, thus causing the present invention to execute the predefined response associated with the value-limit criterion. In addition, the value-limit criterion may include a transaction value range, wherein the transaction value range comprises a lower limit and an upper limit. A different predefined response may be assigned to values between the limits, below the lower limit, and above the upper limit. For example, the user account may configure that a total transaction value within the transaction value range will automatically verify the transaction data and send a notification email/text message to the user account. Alternatively, a transaction value greater than the upper limit will request the user account to verify the transaction data.

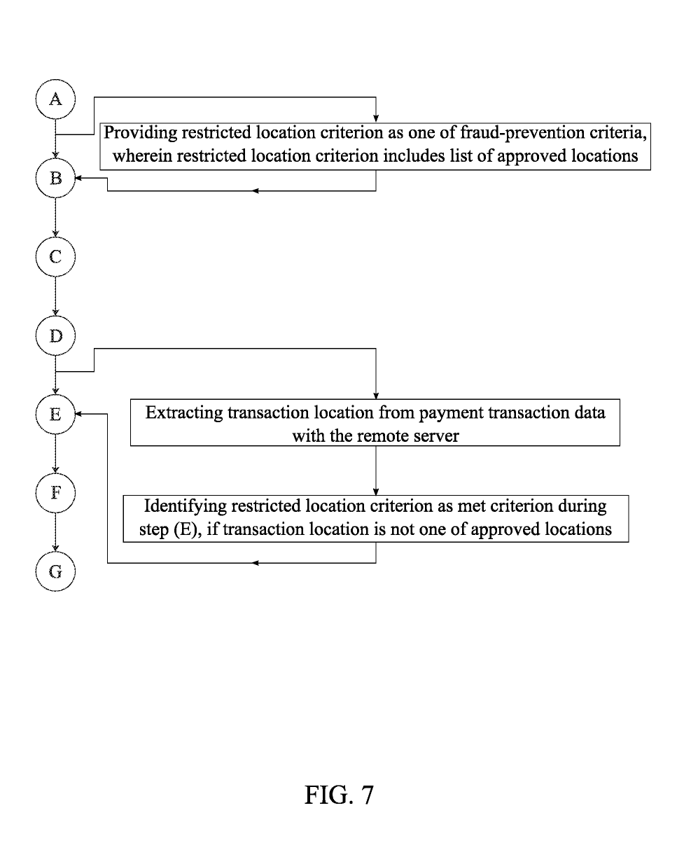

One strong indicator of credit card fraud are transactions and transaction requests from irregular and infrequent regions relative to the cardholder/user. Referring to FIG. 7, the restricted location criterion defines geospatial regions where transactions are allowed and regions where transaction are not allowed. The restriction location criterion includes a list of approved locations provided by the user account that defines a region where he or she regularly uses his or her payment card. In order to check the restricted location criterion, the remote server first extracts a transaction location from the payment transaction data. The transaction location is derived from the merchant, in particular the transaction-acquiring device of the merchant, and is included in the payment transaction data. Next the transaction location is compared to each within the list of approved locations. If the transaction location is not one of the approved locations, then the restricted location criterion is met and identified as the met criterion during Step E, thus causing the present invention to execute the predefined response associated with the restricted location criterion. This essentially allows the user to set a transaction approved zone, outside of which transaction requests indicate potential fraudulent behavior and require user verification immediately. In an alternative embodiment, the restriction location criterion may include a list of disapproved locations where transactions and transaction requests are immediately flagged and reported.

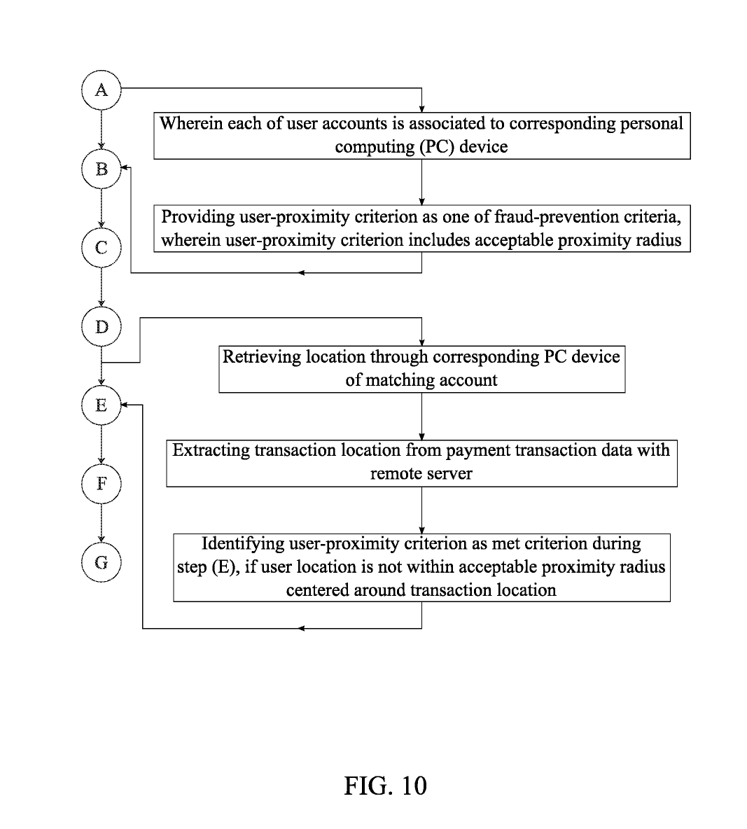

Referring to FIG. 10, the user-proximity criterion adds a layer of protection to the individual by tracking the location of the corresponding PC device and comparing said location to the transaction location in order to determine potential fraudulent behavior. For this feature, the PC device is preferably a smartphone or another similar portable computing device that includes a global positioning system (GPS) device. During the registration process, the user account sets an acceptable proximity radius for the user-proximity criterion. In general, the user-proximity criterion ensures that the user is physically near the transaction location, further indicating the validity of the payment transaction data. The process for checking this criterion includes retrieving a user location through the corresponding PC device of the matching account. Next, the remote server extracts the transaction location from the payment transaction data and compares the transaction location to the user location. If the user location is not within the acceptable proximity radius centered around the transaction location, then the user-proximity criterion is met and identified as the met criterion during Step E, thus causing the present invention to execute the predefined response associated with user-proximity criterion.

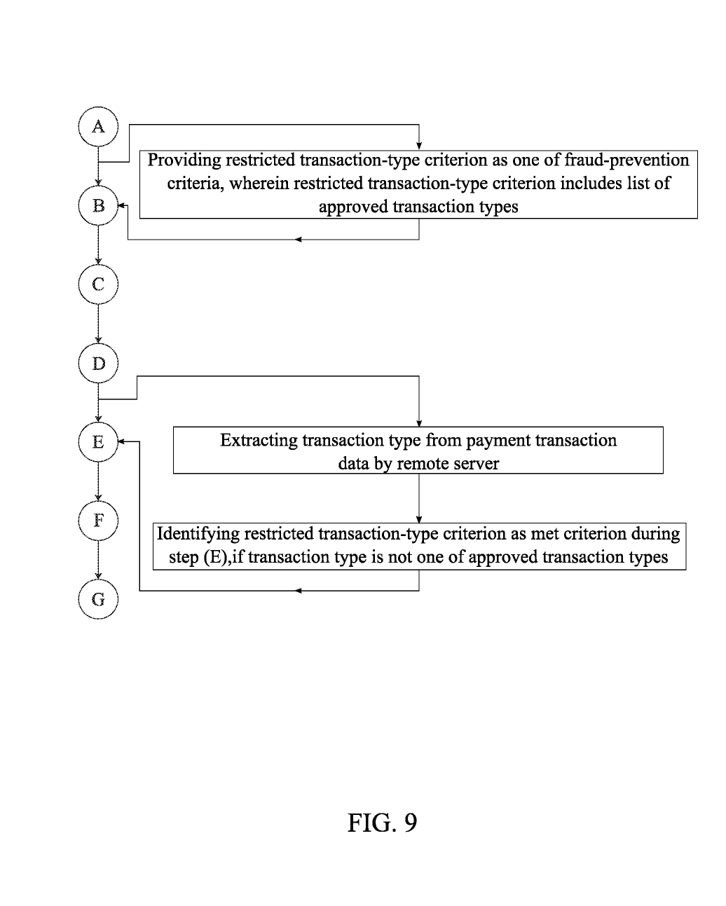

Referring to FIG. 9, the restricted transaction-type criterion limits the type of transactions that may be processed for the associated payment card. The restricted transaction-type criterion includes a list of approved transaction types. Types of transactions include, but are not limited to, web-based transactions, in person transactions, and over-the-phone transactions to name a few non-limiting examples. In order to check this criterion, the remote server first extracts a transaction type from the payment transaction data. Next, the transaction type is compared to the list of approved transaction types. If the transaction type is not one of the approved transaction types, then the restricted transaction-type criterion is met and identified as the met criterion during Step E, thus causing the present invention to execute the predefined response associated with the restricted transaction-type criterion.

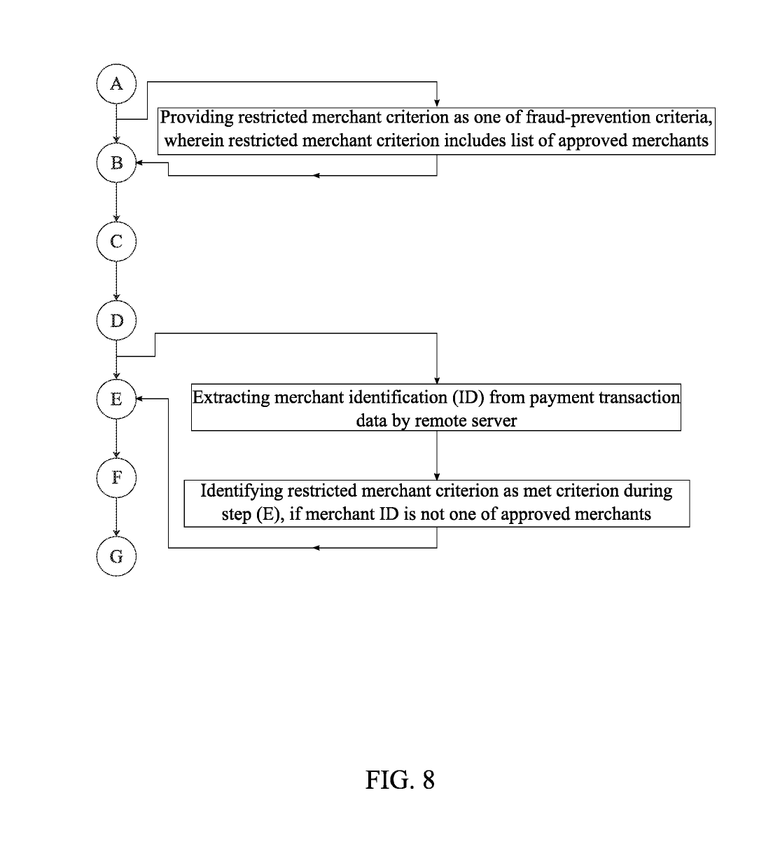

Referring to FIG. 8, the restricted merchant criterion allows the user to manage what type of merchants the associated payment card may be used for. The restricted merchant criterion includes a list of approved merchants. In order to check this criterion, the remote server first extracts a merchant identification (ID) from the payment transaction data. Next, the merchant ID is compared to the list of approved merchants. If the merchant ID is not one of the approved merchants, then the restricted merchant criterion is met and identified during Step E. This allows the user to manage what type of stores and services that the payment card may be used at. More importantly, the restricted merchant criterion allows the user to establish a list of merchants where he or she often visits in order to allows the present invention to easily identify irregular behavior, thus increasing the chances for preventing credit card fraud.

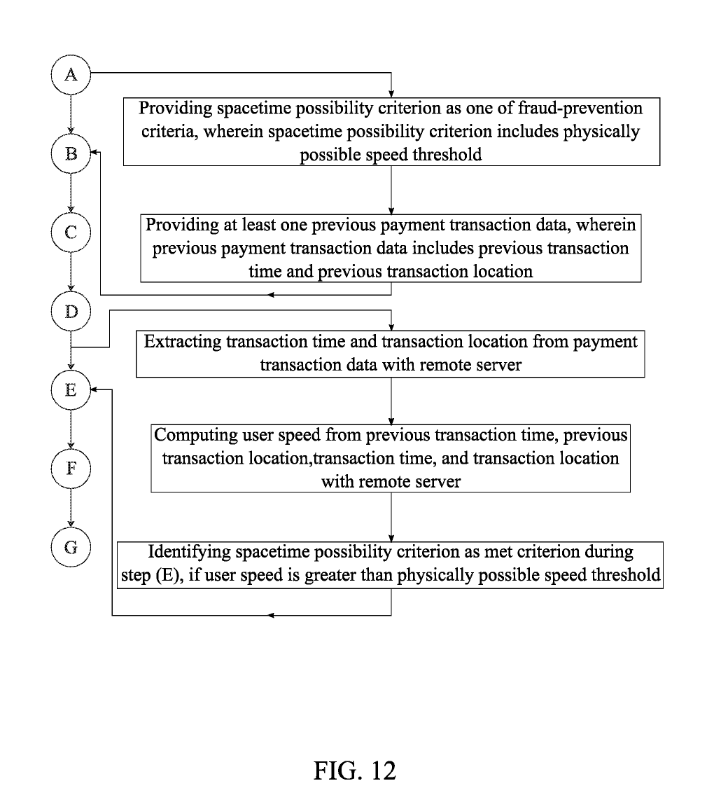

Referring to FIG. 12, the spacetime possibility criterion monitors the transactions and transaction requests to identify irregular behavior based on the probability of two or more transactions occurring at separate locations within a small window of time. For example, if two transaction requests are received by the remote server that are a hundred miles apart in distance and two minutes in time, then these transaction requests will trigger the spacetime possibility criterion. The spacetime possibility criterion includes a physically possible speed threshold, the relatively acceptable speed of an individual. In order to check the spacetime possibility criterion, the remote server compares the payment transaction data against an at least one previous payment transaction data, wherein the previous payment transaction data includes a previous transaction time and a previous transaction location. The remote server first extracts a transaction time and a transaction location from the payment transaction data. Next, the remote server computes a user speed from the previous transaction time, the previous transaction location, the transaction time, and the transaction location. The user speed is calculated by computing the speed required for the user to travel from the previous transaction location to the transaction location in the time difference between the previous transaction time and the transaction time. The user speed is then compared to the physically possible speed threshold.

If the user speed is greater than the physically possible speed threshold, then the spacetime possibility criterion is met and identified during Step E, thus causing the present invention to execute the predefined response associated with the spacetime possibility criterion. The spacetime possibility criterion is used for instances where the information of the payment card is stolen and used in a completely different state or country. This is a common occurrence as a result of identity theft. As this criterion is possible to trigger with regular online purchases, the restricted merchant criterion may be used in conjunction with the spacetime possibility criterion in order to prevent false positive. For example, transaction requests that meet the spacetime possibility criterion may be ignored if the merchant ID associated with the transaction request is included in the list of approved merchants; of course there are situations where this situation could be credit card fraud, that is why the present invention provides the user with a wide variety of fraud-prevention criteria and allows the user to mix and match said criteria to create a portfolio that matches his or her personal preferences and lifestyle.

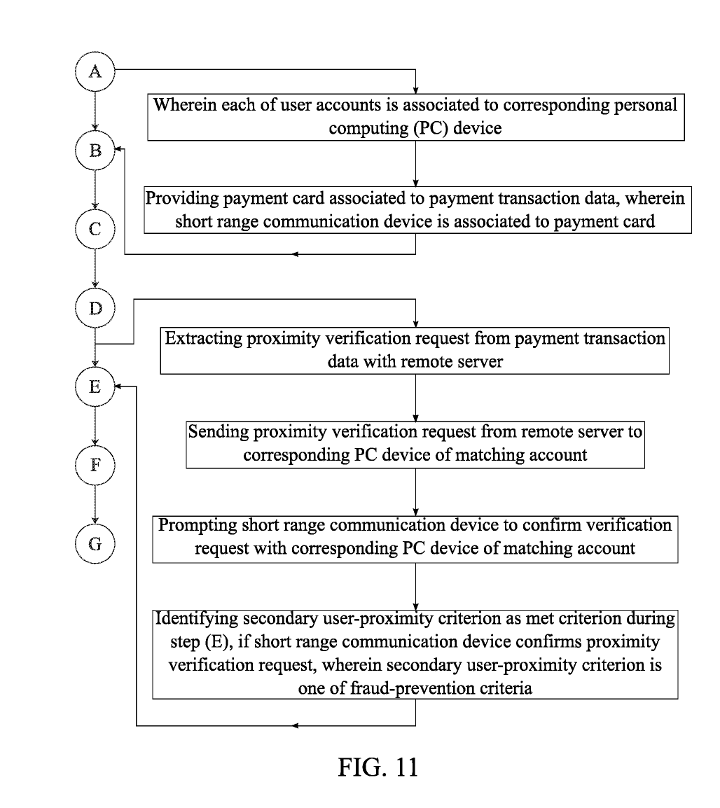

Referring to FIG. 11, the secondary user-proximity criterion provides an additional layer of security by utilizing a separate device to verify the identity and location of the user. More specifically, the secondary user-proximity criterion utilizes a short range communication device that is associated to a payment card, wherein the payment card is associated with the payment transaction data. The short range communication device is any device that is capable of wireless communications and is relatively small in size. Types of devices and technologies that may be used as and/or for the short range communication device include, but are not limited to, near field communication chips, radio-frequency identification tags, Bluetooth devices, and Wi-Fi devices. The short range communication device is preferably small enough to keep on a keychain or in one's pocket.

In order to check the secondary user-proximity criterion, the remote server first extracts a proximity verification request from the payment transaction data. The proximity verification request is included in the payment transaction data if this criterion is included in the plurality of fraud-prevention criteria of the matching account. The proximity verification request is then sent from the remote server to the corresponding PC device of the matching account. Next, the short range communication device is prompted to confirm the verification request with the corresponding PC device of the matching account. This is achieved by the corresponding PC device establishing a wireless connection with the short range communication device, essentially confirming the presence of the short range communication device. If the short range communication device confirms the proximity verification request, then the secondary user-proximity criterion is met and identified during Step E, thus triggering the present invention to execute the predefined response associated with the secondary user-proximity criterion.

The plurality of fraud-prevention criteria may be combined to create a wide range of rules that govern and monitor the transactions and transaction requests of each user account. More specifically, criteria may be configured to depend on other criteria to create a wide variety of complex rules which suit the user's needs and preferences.

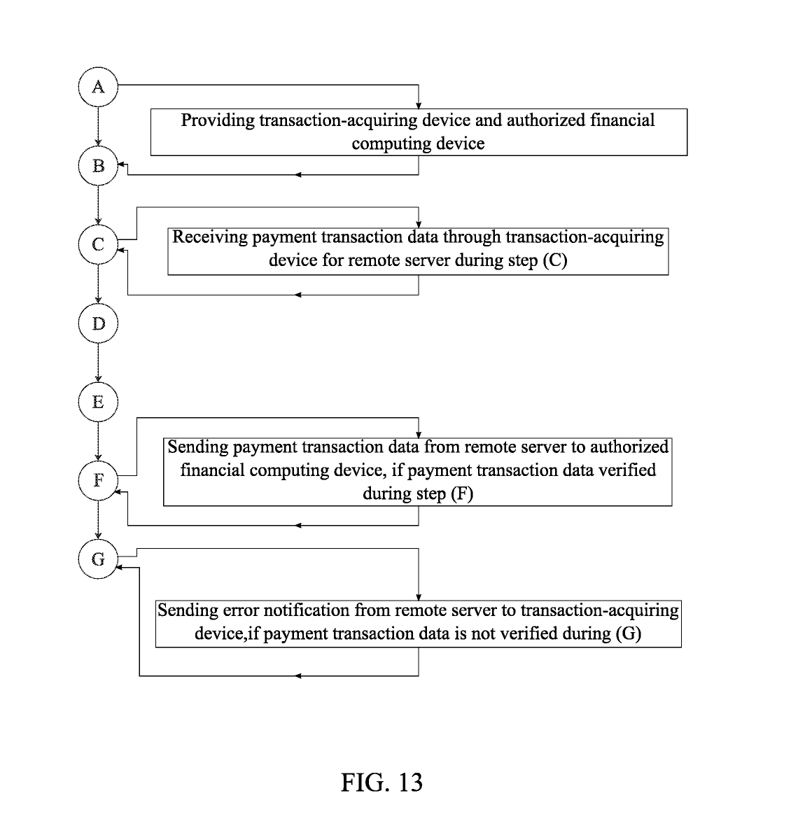

Referring to FIG. 13, in one embodiment, the present invention is implemented prior to the payment transaction data being sent to the authorized financial entity for authorization and execution. In this embodiment, the present invention is implemented as a pre-check system that analyzes all transaction requests before any are sent to the authorized financial entity. First, the payment transaction data is received through transaction-acquiring device for the remote server during Step C. This represents the user providing the merchant with his or her payment information, for example swiping his or her payment card through a credit card reader. Next, the overall process of the present invention is executed, yielding a verified or unverified payment transaction data. If the payment transaction data is verified during Step F, then the payment transaction data is sent from the remote server to the authorized financial computing device for authorization and execution by the authorized financial entity. Alternatively, if the payment transaction data is not verified during Step G, then an error notification is sent from the remote server to the transaction-acquiring device. In this embodiment, any transaction requests that meet any of the fraud-prevention criteria are instantly denied and flagged.

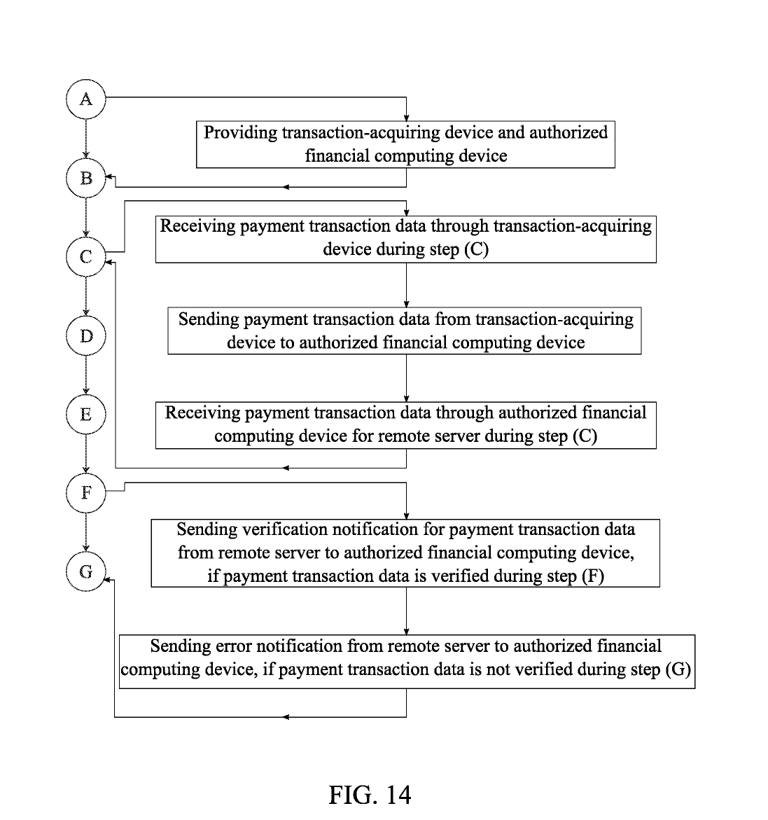

Referring to FIG. 14, in an alternative embodiment, the present invention is implemented after the payment transaction data is authorized by the authorized financial entity. First, the payment transaction data is received through transaction-acquiring device. Next, the payment transaction data is sent from the remote server to the authorized financial computing device directly for authorization. The financial entity associated with the authorized financial computing device then runs transaction authorization procedures. Each transaction authorization is based, almost exclusively, upon five factors: whether the cardholder's account is in good standing; the payment card is a valid card that is not expired or reported lost or stolen; there is a valid security code; a three or four-digit card verification/security code; there is credit availability or sufficient funds in the case of a Debit Card; and whether the merchant account is in good standing. After the payment transaction is authorized, the payment transaction data is received by the remote server during Step C. The overall process is then executed for the payment transaction data, yielding a verified or unverified status. If the payment transaction data is verified during Step F, then a verification notification for the payment transaction data is sent from the remote server to the authorized financial computing device for execution. If the payment transaction data is not verified during Step G, then an error notification is sent from the remote server to the authorized financial computing device.

Although the invention has been explained in relation to its preferred embodiment, it is to be understood that many other possible modifications and variations can be made without departing from the spirit and scope of the invention as hereinafter claimed.

What is claimed is:

1. A method for financial fraud prevention through user-determined regulations comprises the steps of:
(A) providing a plurality of user accounts, wherein each of the users accounts is managed by at least one remote server and is associated with at least one card identification (ID) information;
(B) providing each of the user account with a plurality of fraud-prevention criteria, wherein each of the fraud-prevention criteria is associated to a predefined response;
(C) receiving payment transaction data with the remote server;
(D) comparing the payment transaction data to the card ID information for each of the user accounts with the remote server in order to identify a matching account from the plurality of user accounts;
(E) comparing the payment transaction data against each of the fraud-prevention criteria of the matching account with the remote server in order to identify at least one met criterion from the plurality of fraud-prevention criteria of the matching account;
(F) verifying the payment transaction data with the remote server, if the met criterion is not identified during step (E); and
(G) executing the predefined response associated to the met criterion with the remote server, if the met criterion is identified during step (E).

2. The method for financial fraud prevention through user-determined regulations as claimed in claim 1 comprises the steps of:
wherein each of the user accounts is associated to a corresponding personal computing (PC) device;
prompting to configure the fraud-prevention criteria for each of the user accounts though the corresponding PC device; and
receiving self-defined settings for the fraud-prevention criteria for an at least one primary account through the corresponding PC device, wherein the primary account is one of the plurality of user accounts.

3. The method for financial fraud prevention through user-determined regulations as claimed in claim 2 comprises the steps of:
providing a secondary account from the plurality of user accounts, wherein the secondary account is dependently associated with the primary account; and
receiving else-defined settings for the fraud-prevention criteria for the secondary account from the primary account through the corresponding PC device.

4. The method for financial fraud prevention through user-determined regulations as claimed in claim 1 comprises the steps of:
wherein each of the user accounts is associated to a corresponding personal computing (PC) device;
providing a library of fraud-prevention criteria, wherein the library of fraud-prevention criteria is stored on the remote server; and
prompting to select the plurality of fraud-prevention criteria for each of the user accounts from the library of fraud-prevention criteria through the corresponding PC device.

5. The method for financial fraud prevention through user-determined regulations as claimed in claim 1 comprises the steps of:
providing a value-limit criterion as one of the fraud-prevention criteria, wherein the value-limit criterion includes a maximum transaction value;
extracting a total transaction value from the payment transaction data with the remote server; and
identifying the value-limit criterion as the met criterion during step (E),
if the total transaction value is greater than the maximum transaction value.

6. The method for financial fraud prevention through user-determined regulations as claimed in claim 1 comprises the steps of:
providing a restricted location criterion as one of the fraud-prevention criteria, wherein the restricted location criterion includes a list of approved locations;
extracting a transaction location from the payment transaction data with the remote server; and
identifying the restricted location criterion as the met criterion during step (E),
if the transaction location is not one of the approved locations.

7. The method for financial fraud prevention through user-determined regulations as claimed in claim 1 comprises the steps of:
wherein each of the user accounts is associated to a corresponding personal computing (PC) device;
providing a user-proximity criterion as one of the fraud-prevention criteria, wherein the user-proximity criterion includes an acceptable proximity radius;
retrieving a user location through the corresponding PC device of the matching account;
extracting a transaction location from the payment transaction data with the remote server; and
identifying the user-proximity criterion as the met criterion during step (E),
if the user location is not within the acceptable proximity radius centered around the transaction location.

8. The method for financial fraud prevention through user-determined regulations as claimed in claim 1 comprises the steps of:
wherein each of the user accounts is associated to a corresponding personal computing (PC) device;
providing a payment card associated to the payment transaction data, wherein a short range communication device is associated to the payment card;
extracting a proximity verification request from the payment transaction data with the remote server;
sending the proximity verification request from the remote server to the corresponding PC device of the matching account;
prompting the short range communication device to confirm the verification request with the corresponding PC device of the matching account; and
identifying a secondary user-proximity criterion as the met criterion during step (E),
if the short range communication device confirms the proximity verification request,
wherein the secondary user-proximity criterion is one of the fraud-prevention criteria.

9. The method for financial fraud prevention through user-determined regulations as claimed in claim 1 comprises the steps of:
wherein each of the user accounts is associated to a corresponding personal computing (PC) device;
providing the met criterion is identified during step (E);
sending a verification request from the remote server to the corresponding PC device of the matching account, wherein the user verification request includes the payment transaction data and the met criterion;
prompting the matching account to verify or deny the payment transaction data through the corresponding PC device;
sending a verification notification for the payment transaction data from the corresponding PC device of the matching account to the remote server;
if the matching account verifies the payment transaction data with the corresponding PC device; and
sending an error notification from the corresponding PC device of the matching account to the remote server,
if the matching account does not verify the payment transaction data.

10. The method for financial fraud prevention through user-determined regulations as claimed in claim 1 comprises the steps of:
providing a spacetime possibility criterion as one of the fraud-prevention criteria, wherein the spacetime possibility criterion includes a physically possible speed threshold;
providing an at least one previous payment transaction data, wherein the previous payment transaction data includes a previous transaction time and a previous transaction location;
extracting a transaction time and a transaction location from the payment transaction data with the remote server;
computing a user speed from the previous transaction time, the previous transaction location, the transaction time, and the transaction location with the remote server; and
identifying the spacetime possibility criterion as the met criterion during step (E),
if the user speed is greater than the physically possible speed threshold.

11. The method for financial fraud prevention through user-determined regulations as claimed in claim 1 comprises the steps of:
providing a restricted merchant criterion as one of the fraud-prevention criteria, wherein the restricted merchant criterion includes a list of approved merchants;
extracting a merchant identification (ID) from the payment transaction data by the remote server; and
identifying the restricted merchant criterion as the met criterion during step (E),
if the merchant ID is not one of the approved merchants.

12. The method for financial fraud prevention through user-determined regulations as claimed in claim 1 comprises the steps of:
providing a restricted transaction-type criterion as one of the fraud-prevention criteria, wherein the restricted transaction-type criterion includes a list of approved transaction types;
extracting a transaction type from the payment transaction data by the remote server; and
identifying the restricted transaction-type criterion as the met criterion during step (E),
if the transaction type is not one of the approved transaction types.

13. The method for financial fraud prevention through user-determined regulations as claimed in claim 1 comprises the steps of:
providing a transaction-acquiring device and an authorized financial computing device;
receiving the payment transaction data through the transaction-acquiring device for the remote server during step (C);
sending the payment transaction data from the remote server to the authorized financial computing device,
if the payment transaction data is verified during step (F); and
sending an error notification from the remote server to the transaction-acquiring device,
if the payment transaction data is not verified during (G).

14. The method for financial fraud prevention through user-determined regulations as claimed in claim 1 comprises the steps of:
providing a transaction-acquiring device and an authorized financial computing device;
receiving the payment transaction data through the transaction-acquiring device during step (C);
sending the payment transaction data from the transaction-acquiring device to the authorized financial computing device;
receiving the payment transaction data through the authorized financial computing device for the remote server during step (C);
sending a verification notification for the payment transaction data from the remote server to the authorized financial computing device,
if the payment transaction data is verified during step (F); and
sending an error notification from the remote server to the authorized financial computing device,
if the payment transaction data is not verified during step (G).
